(19) United States
(12) Patent Application Publication
(10) Pub. No.: US 2013/0112589 A1
(43) Pub. Date: May 9, 2013

(54) Drainage Kit With Built-In Disposal Bag

(71) Applicants: Khoa T. Lien, Milton, GA (US); Henry L. Griesbach, III, Atlanta, GA (US); James B. Robinson, Cumming, GA (US)

(72) Inventors: Khoa T. Lien, Milton, GA (US); Henry L. Griesbach, III, Atlanta, GA (US); James B. Robinson, Cumming, GA (US)

(21) Appl. No.: 13/289,401

(22) Filed: Nov. 4, 2011

(51) Int. Cl. B65D 69/00; B31B 1/26

(52) U.S. Cl. 206/570; 493/240

(57) ABSTRACT

The present disclosure describes a disposal bag, kit and method for performing pleural drainage that may be used by a patient at home or away from home. The kit for drainage of a body cavity has instruments and supplies needed to drain the body cavity, a disposal bag made from two superposed, water impervious sheets sealed about a substantial portion of their perimeter using a water impervious bond. The bag is usable for disposal of the instruments and supplies after drainage of the body cavity. The superposed sheets also provide a work sheet to prepare and use the instruments and supplies.

### BACKGROUND

The present disclosure relates to an apparatus and method for draining fluids from a body.

Fluid production in a part of the human body like the chest may be caused by disease, injury or as a result of surgery. The medical professional, a care giver or the patient if he is capable, may need to drain such pleural effusion fluids that accumulate at the site of an injury to relieve pressure felt by the patient and to remove the excess fluid that may harbor infection. Drainage from the thoracic cavity or pleural cavity surrounding the lungs, known as pleural drainage, is commonly performed by the patient at home or at work. Typically, a short length of tubing is surgically installed in the pleural cavity with an end terminating outside the body. The surgically implanted tubing begins in the thoracic cavity and ends outside the patient's body. The tubing is normally installed under local anesthesia.

To drain the pleural cavity, a chest drainage canister is normally attached via tubing to the tubing that was surgically installed in the patient's chest to drain fluid. Some systems use a plastic bag or other container in place of the chest drainage canister. Drainage may occur at any time interval as determined by the patient's level of discomfort and may take from a few minutes to an hour.

Current pleural drainage kits consist of a drainage bag with associated tubing, alcohol pads/wipes, gloves and a few other ancillary items. Existing kits do not generally contain a material or fabric to form a clean work sheet for preparation, nor do they contain a disposal means. After usage, patients using current kits find they must discretely dispose of the fluid filled drainage bag as well as the rest of the components of the kit. This can be a source of some embarrassment for the patient, causing some to use, for example, brown paper bags to contain the waste materials. This problem is particularly acute when the patient must perform the pleural drainage at a work location.

What is needed is a kit and method for performing pleural drainage that is easy to use and provides a clean work sheet and discrete disposal means.

### SUMMARY

The present disclosure describes a disposal bag, kit and method for performing pleural drainage that may be used by a patient at home or away from home.

The disposal bag is made from at least two superposed flexible flat sheets continuously attached together about a substantial portion of the periphery of the bag. The sheets can be of the same size or one sheet can be larger than the other. The superposed sheets form an upper surface and a lower surface that also form the upper surface of the bag and the lower surface of the bag. A portion, e.g. a corner, of the periphery is left unattached so that the bag may be opened and used for disposal of the kit contents after use. The sheets may desirably be made from non-woven fabric and still more desirably be impervious to water so that the disposal bag does not leak after the contents are inserted into the bag after use. One way of making the flat sheets water-impervious is by including a film layer as part of each of the sheets that form the bag.

The bag may further have instructions for use of the drainage kit printed on it on either or both sheet and may have symbolic instructions as well.

The kit for drainage of a body cavity has instruments and supplies needed to drain the body cavity as well as a disposal bag made from two superposed, water impervious sheets, sealing about a substantial portion of the bag's periphery using a water impervious bond pattern, the bag being usable for disposal of the instruments and supplies after drainage of the body cavity. The kit may also contain gloves and a drainage bag. The kit also has a work surface that is formed from or on the upper surface of the superposed sheets; this work surface includes a substantial portion of the upper surface of the bag.

Also provided is a method of folding the sheets around instruments and supplies, i.e. the kit contents, to form the drainage kit.

The steps of folding include:
laying the superposed sheets making up the bag unfolded and flat, the superposed sheets having upper, lower, left (open) and right corners,
desirably placing the kit contents on the upper surface of one of the superposed sheets and to one side of a diagonal line that spans from the right to the left corners,
folding up either the lower or the upper corner that is opposite the diagonal line and closest to the kit contents and at least partially over the kit contents to form an initial folded corner that is substantially parallel to and spaced away from the diagonal fold line,
folding up and back from the tip of the folded corner a portion of the initial folded corner so that the tip lies a short distance beyond the first fold line,
folding the corner that is opposite the initial folded corner up and over on the diagonal fold line,
folding up the left corner and over portions of the previous folds so that the tip of the left corner lies approximately along the diagonal line and a second fold line is formed that is substantially perpendicular to the diagonal line,
folding the right corner up and over or towards the tip of the left corner and along the diagonal line and towards the second fold line but not beyond the second fold line,
folding up and over the corner that is opposite the initial folded corner so that the tip of this corner crosses a short distance beyond the diagonal line and tucking a portion of this corner over the diagonal line and under the overlaying sheets caused by folding the left corner. This provides a folded kit with the kit contents securely located inside. The folded kit is easily opened by pulling the upper and lower corners outwards from each other, making the contents immediately available for use.

Other objects, advantages and applications of the present disclosure will be made clear by the following detailed description of a preferred embodiment of the disclosure and the accompanying drawings wherein reference numerals refer to like or equivalent structures.

### BRIEF DESCRIPTION OF THE DRAWINGS

FIG. 1 is a drawing of an exemplary disposal bag which is made from two superposed sheets that are formed from at least two sheets that are joined together in a desirably liquid impervious or leak-proof seal for most of their perimeter.

FIGS. 2 through 9 show the unique folding technique used with for the disposal kit.

FIG. 2 shows the bag of FIG. 1 with the kit contents placed on it. FIG. 2 has an arrow showing the direction of the first fold wherein the lower corner is brought up over at least some of the kit contents and towards a diagonal line between the left and right corners.

FIG. 3 shows that the lower corner folded up and over portions of the kit contents so that the tip of the corner is a short distance across the diagonal line of FIG. 2.

FIG. 4 shows that the tip of the lower corner folded back on the portion that was folded upwardly in FIG. 2. FIG. 4 has an arrow indicating that the upper corner should be folded over the folded lower corner along the diagonal line.

FIG. 5 shows the upper corner after it has been folded up and over the lower corner along the diagonal line. An arrow in FIG. 5 indicates that the left corner should be folded in the direction of the right corner.

FIG. 6 shows the left corner after it has been folded and has an arrow that indicates that the right corner should be folded up and over the left corner.

FIG. 7 shows the right corner after it has been folded and has an arrow that indicates that the lower corner should be folded up and over so that the tip of the lower corner is across the diagonal line.

FIG. 8 shows the lower corner after folding and has an arrow indicating that a portion of the lower corner, now at the top of the figure after folding, should be tucked downwardly within previous folds.

FIG. 9 shows the finished kit after the tuck indicated by the arrow in FIG. 8 has been performed. As a final fold, the tip of the lower corner projects upwardly from the tucked portion to provide a place for a user to grab the kit for unfolding.

FIG. 10 again shows the finished package from FIG. 9 but with indicator arrows showing how the kit can be opened by pulling on the projecting left and right corners form the other folded sheets. Grasping the corners as indicated and gently pulling in opposite directions results in the opening of the package for use as shown in FIG. 11.

FIG. 11 shows the kit after opening. The work sheet and the kit are clearly visible and the kit for pleural drainage is available for usage.

FIG. 12 shows the bag being opened by a user and the used kit contents being inserted (arrow) for disposal.

FIG. 13 shows the kit and bag after the used materials have been inserted into the bag. FIG. 13 shows that the opposing corners may be used to tie the bag closed if desired.

FIG. 14 shows another exemplary bag which is made from two superposed sheets that are joined together in a desirably liquid impervious or leak-proof bond for most of their perimeter but with bond portions within the perimeter of the two supposed sheets.

FIG. 15 shows another exemplary bag which is made from two superposed sheets that are formed from one larger folded sheet.

FIG. 16 shows another embodiment of the bag in which the sheets are of different sizes.

### DETAILED DESCRIPTION

Reference will now be made to the drawings in which the various elements of the present disclosure will be given numeral designations and in which the disclosure will be discussed so as to enable one skilled in the art to make and use the disclosure. It is to be understood that the following description is only exemplary of the principles of the present disclosure, and should not be viewed as narrowing the pending claims. Those skilled in the art will appreciate that aspects of the various embodiments discussed may be interchanged and modified without departing from the scope and spirit of the disclosure.

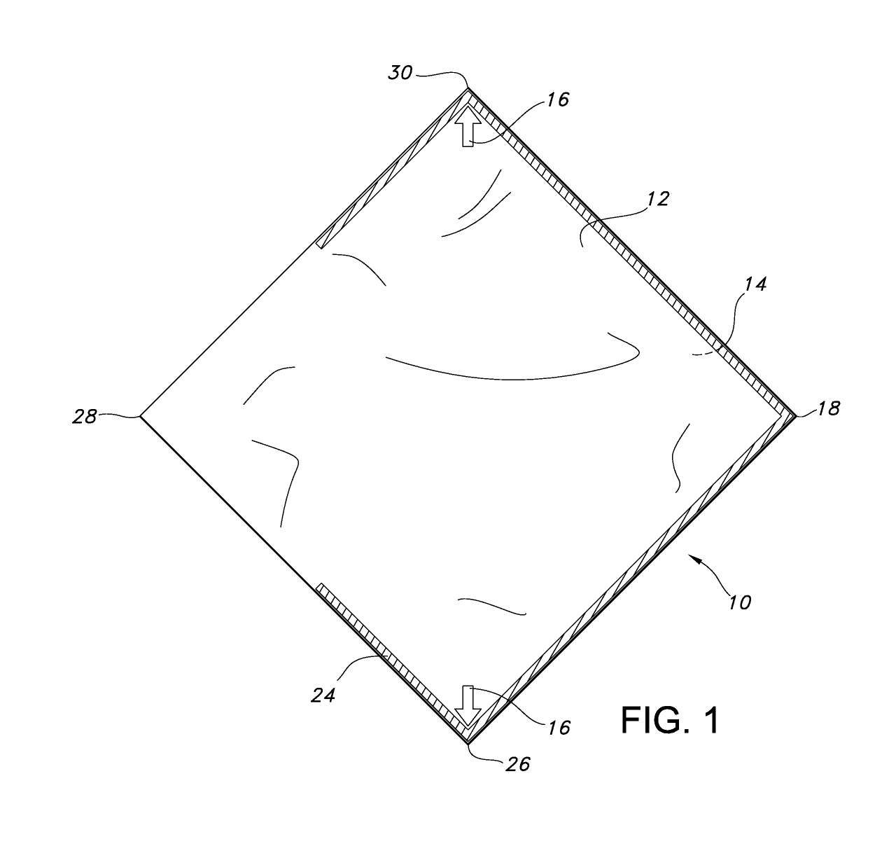

FIG. 1 shows a drawing of two superposed sheets 12, 14 that form a disposal bag 10. In this embodiment the bag 10 is approximately 40 cm by 40 cm, though a bag of virtually any size or shape may be produced. The bag 10 may be square, as in the embodiment or may be rectangular, circular or any other shape desired, so long as it functions in the manner described herein. Additionally, the superposed sheets that form the bag need not be the same shape as each other. One sheet may be square or rectangular for example, while the other is round or oval. Numerous other combinations of size and shape can clearly be envisioned, based on the needs of the user.

The bag 10 is made from at least two superposed sheets 12, 14 that are joined together in a desirably liquid impervious or leak-proof seal 24 for a substantial portion of their perimeter. By “perimeter” it is meant the outer edge of the smaller sheet if the sheets are of differing size, or, alternatively, the outer edges of both sheets if the sheets are substantially the same size.

By “a substantial portion of their perimeter” it is meant that the perimeter is sealed for a length equal to between 50 and 90 percent of the total perimeter length, more particularly for a length equal to between 70 and 80 percent of the length. It is desirable that the unsealed portion of the perimeter be at a corner since it is believed that such a configuration would make the use of the bag easier, though it is not required that the unsealed portion be at a corner.

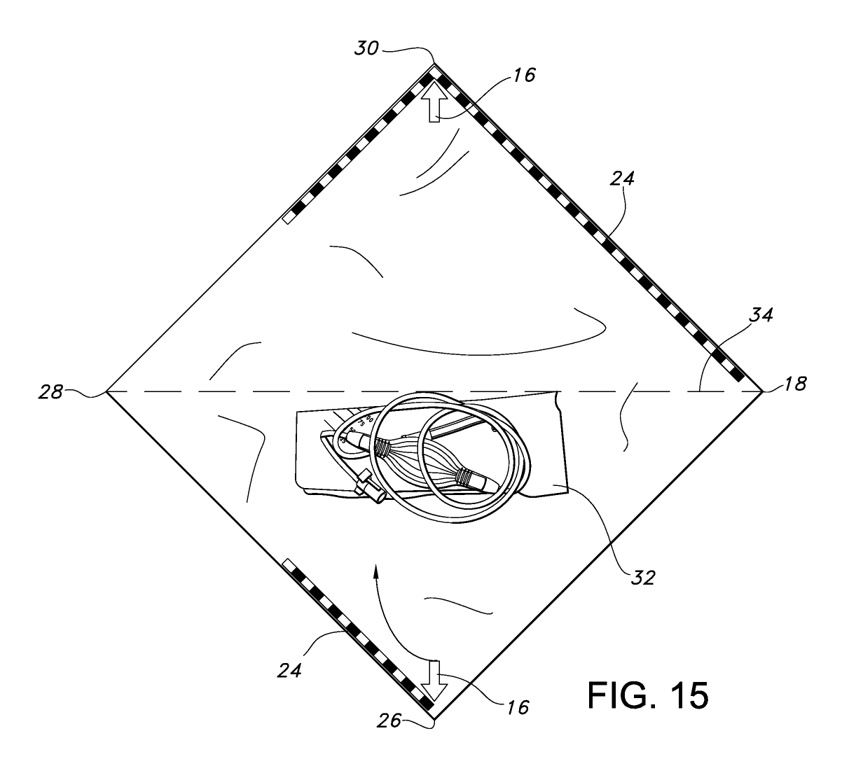

The sheets 12, 14 may be the same or different in construction but are desirably liquid impervious so that any contents of the bag 10 do not leak. One suitable material for the production of the sheets is nonwoven fabric; another suitable material is film. The sheets may be, for example, a laminate of spunbond layers and film layers, the film layer providing the liquid imperviousness to the bag. Alternatively the sheets may be a laminate of spunbond and meltblown fabrics wherein the meltblown layer or layers provide the liquid imperviousness. It should be noted that although the term “sheets” evokes separate pieces of material, the sheets are not required to be separate pieces to begin with but may be a single larger sheet that is folded over onto itself as shown in FIG. 15. The 40 cm by 40 cm embodiment of FIG. 1 may alternatively be made, for example, by folding a 40 cm by 80 cm single piece onto itself and bonding the perimeter over one side adjacent the fold and less than the entirety of the perimeter of the two remaining sides, as will be explained below. If a single piece of material is folded onto itself to form the bag 10, the length of the fold should be included in the calculation of the length of the perimeter; i.e., the fold is part of the perimeter. The two sheets 12, 14 are joined together in a manner that forms a bag that is desirably flat before being opened and so does not form a three dimensional structure prior to being intentionally opened by a user.

As used herein the term “nonwoven fabric or web” means a web having a structure of individual fibers or threads which are interlaid, but not in an identifiable manner as in a knitted fabric. Nonwoven fabrics or webs have been formed from many processes such as for example, meltblowing processes, spunbonding processes, and bonded carded web processes. The basis weight of nonwoven fabrics is usually expressed in ounces of material per square yard (osy) or grams per square meter (gsm) and the fiber diameters useful are usually expressed in microns. (Note that to convert from osy to gsm, multiply osy by 33.91).

As used herein the term “spunbonded fibers” refers to small diameter fibers which are formed by extruding molten thermoplastic material as filaments from a plurality of fine, usually circular capillaries of a spinneret with the diameter of the extruded filaments then being rapidly reduced as by, for example, in U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, and U.S. Pat. No. 3,542,615 to Dobo et al. Spunbond fibers are generally not tacky when they are deposited onto a collecting sheet. Spunbond fibers are generally continuous and have average diameters (from a sample of at least 10) larger than 7 microns, more particularly, between about 10 and 20 microns. The fibers may also have shapes such as those described in U.S. Pat. No. 5,277,976 to Hogle et al., U.S. Pat. No. 5,466,410 to Hills and 5,069,970 and 5,057,368 to Largman et al., which describe fibers with unconventional shapes.

As used herein the term “meltblown fibers” means fibers formed by extruding a molten thermoplastic material through a plurality of fine, usually circular, die capillaries as molten threads or filaments into converging high velocity, usually hot, gas (e.g. air) streams which attenuate the filaments of molten thermoplastic material to reduce their diameter, which may be to microfiber diameter. Thereafter, the meltblown fibers are carried by the high velocity gas stream and are deposited on a collecting sheet to form a web of randomly dispersed meltblown fibers. Such a process is disclosed, for example, in U.S. Pat. No. 3,849,241 to Butin et al. Meltblown fibers are microfibers which may be continuous or discontinuous, are generally smaller than 10 microns in average diameter, and are generally tacky when deposited onto a collecting sheet.

The leak-proof seal 24 is desirably a bar seal, lines of adhesive, or other types of continuous bonds that impart liquid impermeability to the seal area so that liquid does not leak from the interior of the bag 10 through the bond.

As used herein, “ultrasonic bonding” means a process performed, for example, by passing the fabric between a sonic horn and anvil roll as illustrated in U.S. Pat. No. 4,374,888 to Bornslaeger. “Thermal bonding” involves passing a fabric or web of fibers to be bonded between a heated calender roll and an anvil roll. The rolls may have patterns or may produce a continuous bond, as desired.

In the embodiment described in FIG. 1, the leak-proof seal 24 is continuous except for an area approaching the corner 28. Corner 28 is open due to the lack of bonding between the edges of the two sheets 12, 14. In this embodiment the adjacent sides making up the open corner 28 are unbonded for about half of their length, or 20 cm in this case. The amount of unbonded length of the sides may vary but is needed to allow a user to separate the two sheets 12, 14 in the open corner 28 to insert used items into the interior of the bag 10 for disposal. The two opposing corners, lower 26 and upper 30 of FIG. 1, respectively, are, in this embodiment, each marked with a printed arrow 16 that will be used to indicate to the user how to open the completed kit. The use of indicia to aid the user will be discussed at greater length below.

The contents of the kit 32 that is used for pleural drainage that may be disposed of in the bag 10 include, for example, gloves, a plastic bag for receiving the drainage fluid from the chest, tubing and a squeezable bulb in the tubing line to facilitate drainage. Other items as may be needed may also be enclosed. The kit contents 32 is packaged within the bag 10 prior to use, as will be explained below.

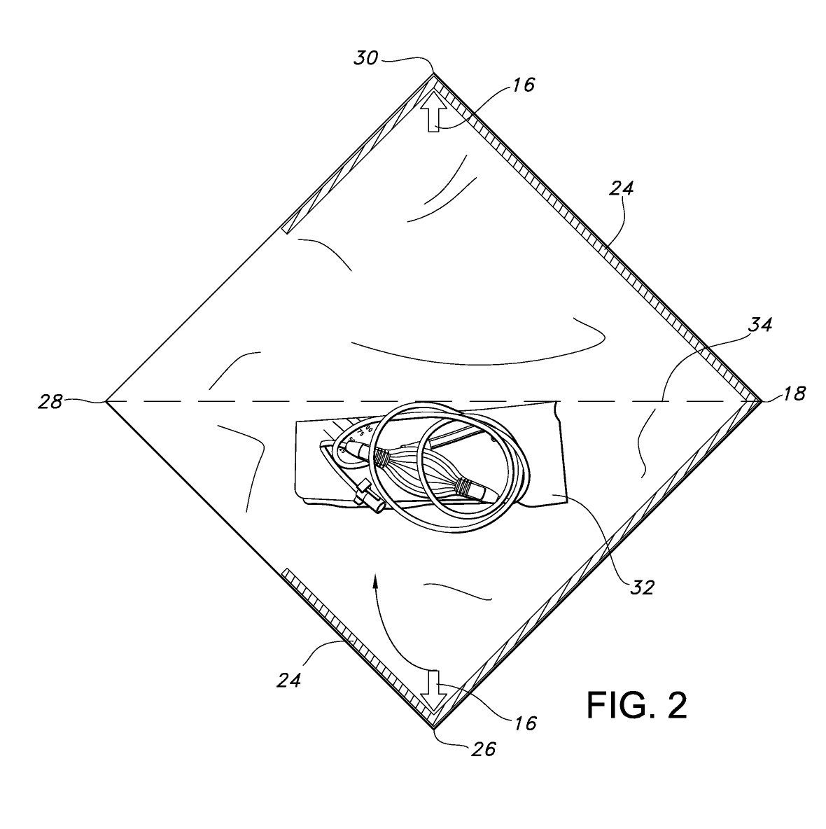

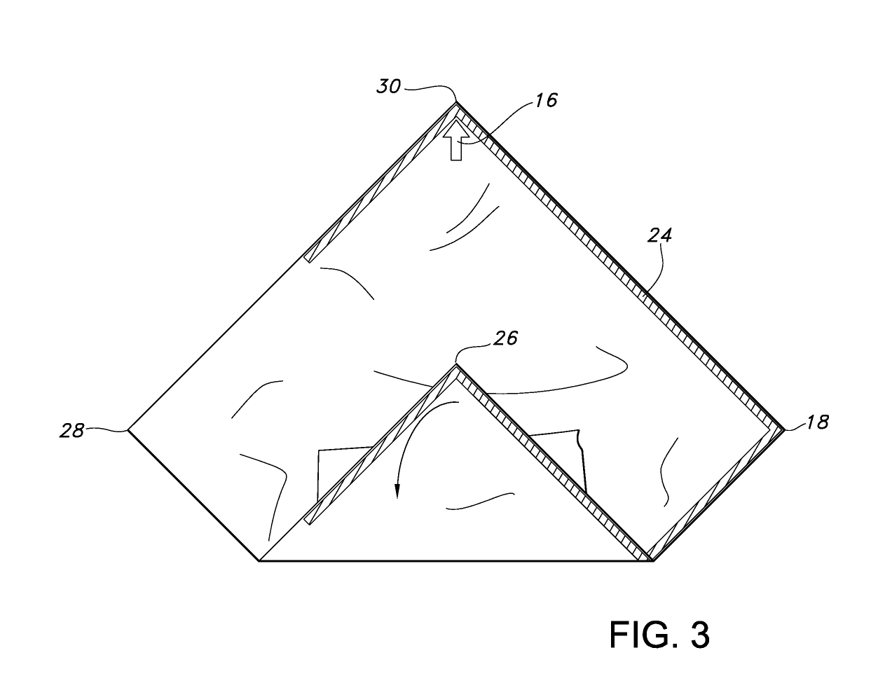

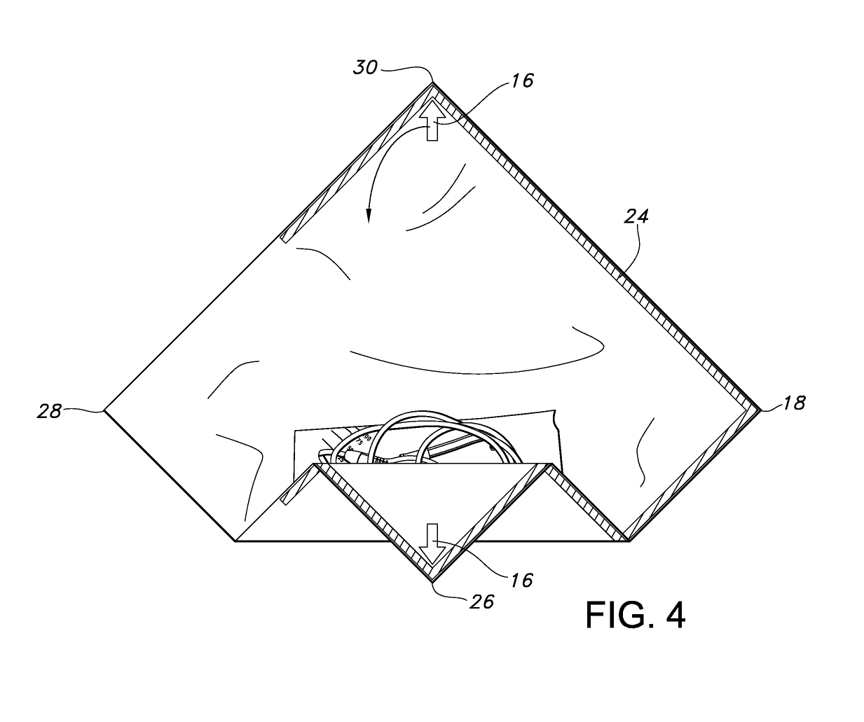

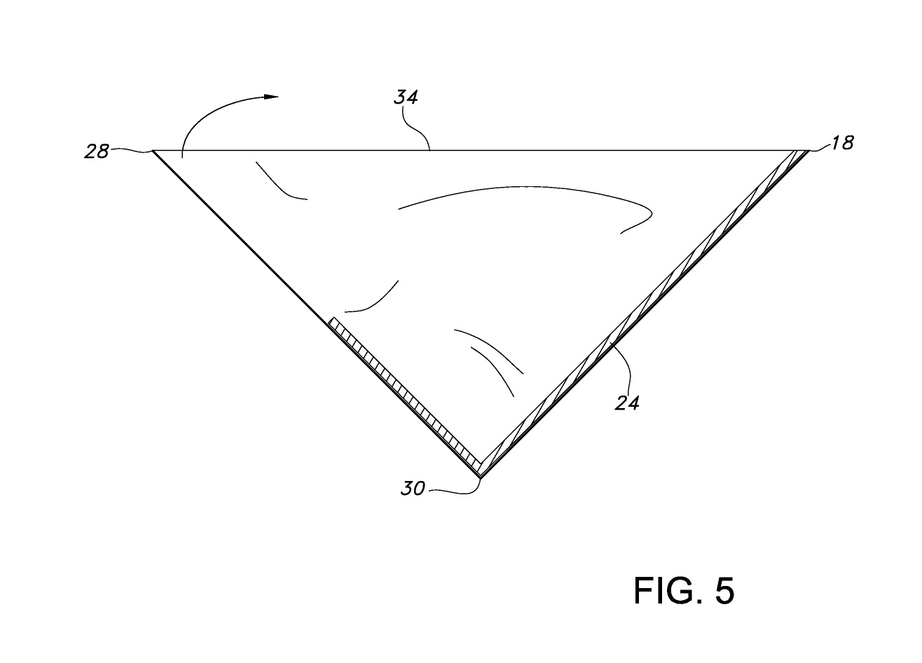

FIGS. 2 through 9 show the unique folding technique used with the disposal device. In the Figures, the open corner 28 is the corner on the far left. The kit contents 32 are placed on one sheet just to one side of a line 34 (dashed) going from one corner 28 to an opposite corner 18, e.g. just below the center line 34 in FIG. 2. The kit contents are not disposed between the sheets 12, 14, i.e., within the bag 10, for packaging but are merely laid upon the open sheet. FIG. 2 has an instructional arrow showing the direction of the first fold. FIG. 3 shows that; the lower corner 26 is brought up over the kit contents 32 and towards and/or over the diagonal line, e.g., for approximately half of the distance between the lower corner 26 and the left and right corners 18, 28. FIG. 4 shows that approximately 5 to 10 cm of the tip of the lower corner 26 are folded back on the portion that was folded upwardly in FIG. 3. The upper corner 30 is brought over the rest of the bag 10 and folded along the diagonal line 34 as shown in FIG. 5.

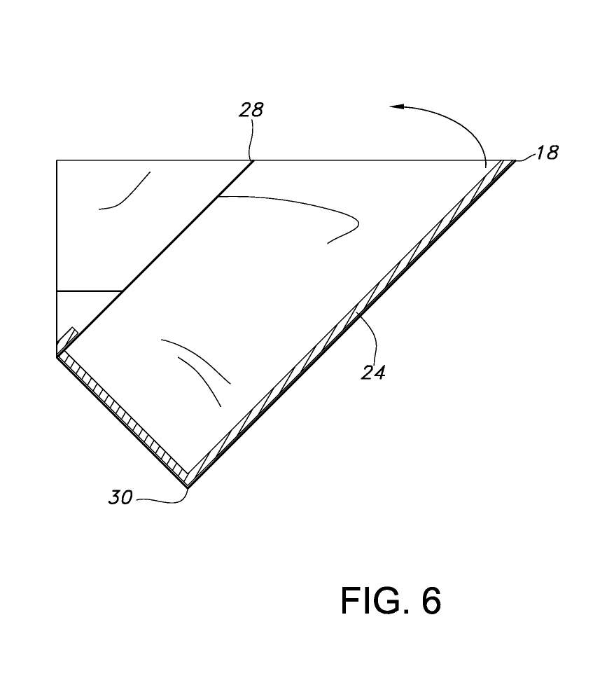

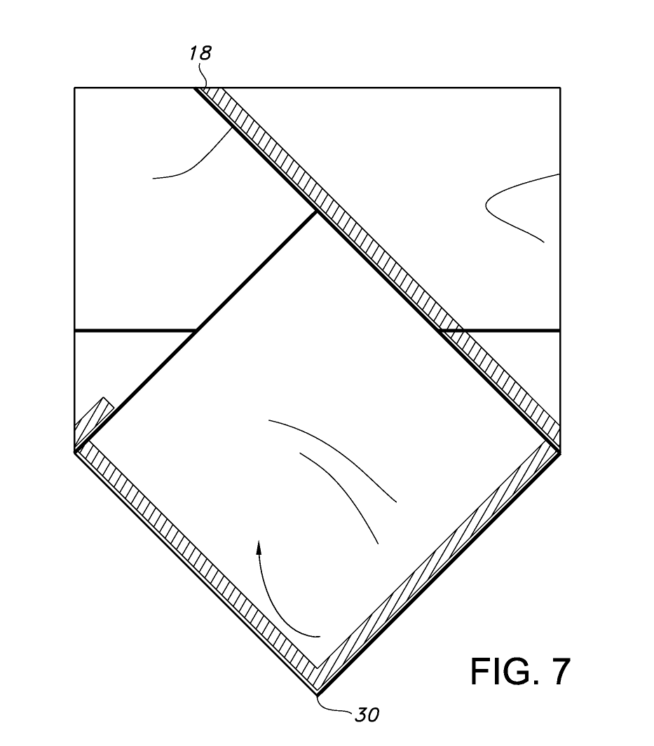

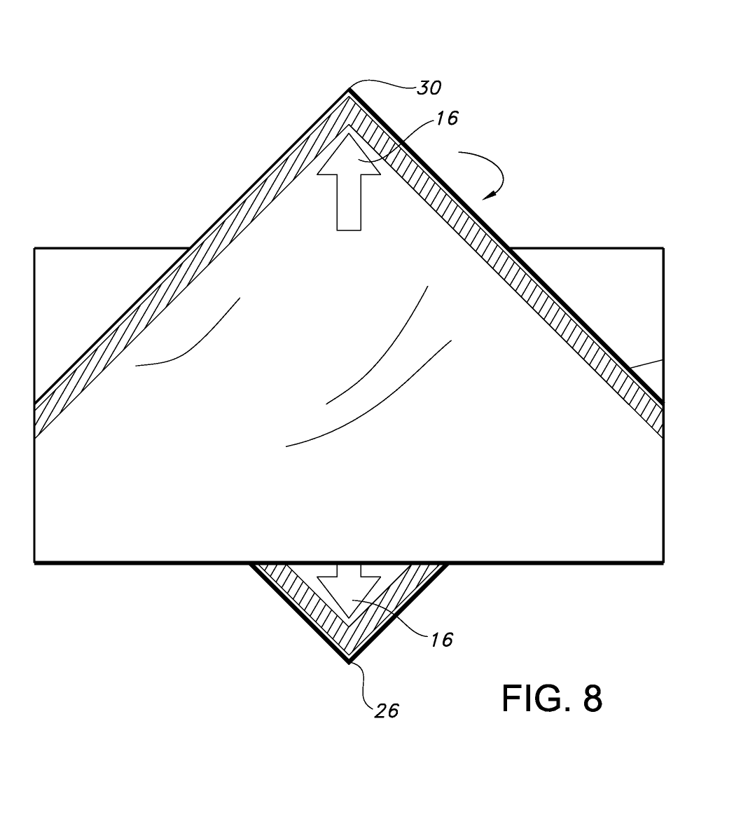

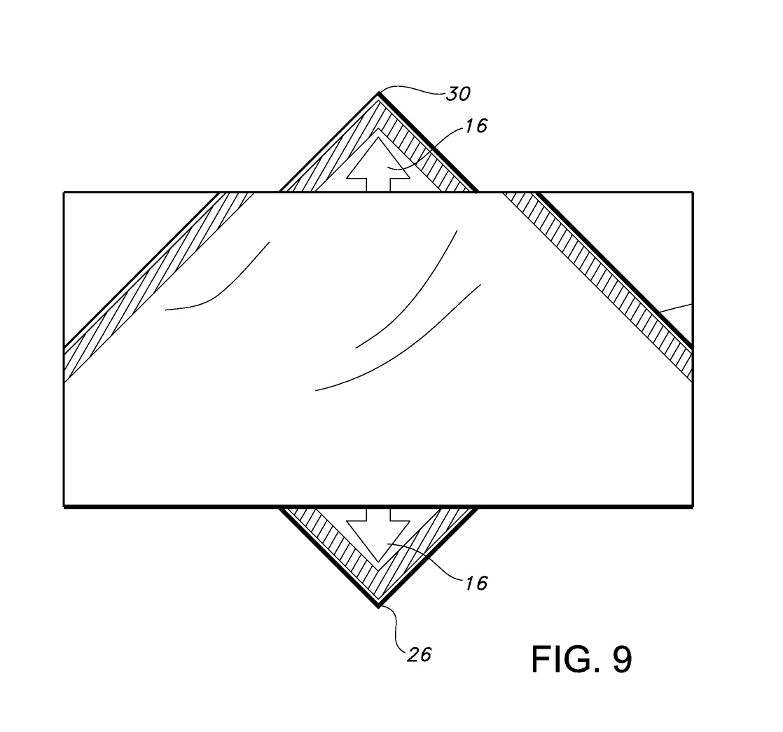

FIGS. 6 through 9 show the folding of the sides and upper 30 and lower corners 26 to produce the final kit. In FIG. 6 the left corner 18 is shown folded over a portion of the bag 10 according to the instructional arrow in FIG. 5. An instructional arrow in FIG. 6 shows how the right hand corner 18 is folded in a mirror image of the folding of the left corner 28. The upper corner 30, located now at the bottom of the FIG. 7 after being folded over (per FIG. 5) is then folded upwardly as shown by the instructional arrow. An instructional arrow in FIG. 8 indicates that the end of corner 30 is tucked within previously folded portions and the tip of corner 30 is folded upwards and projected out from the tuck. This results in the final packaged kit as shown in FIG. 9, with the tips of the upper and lower corners 30, 26 exposed.

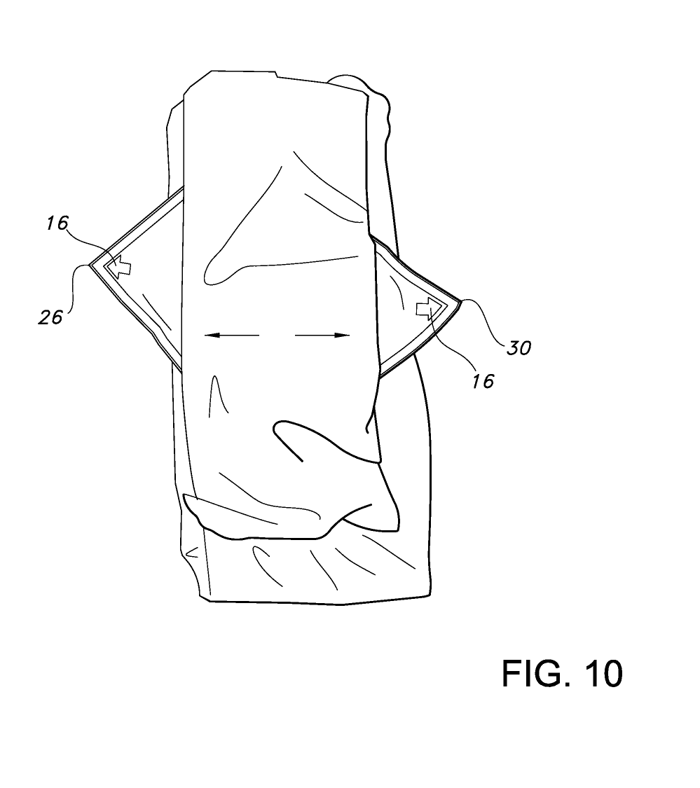

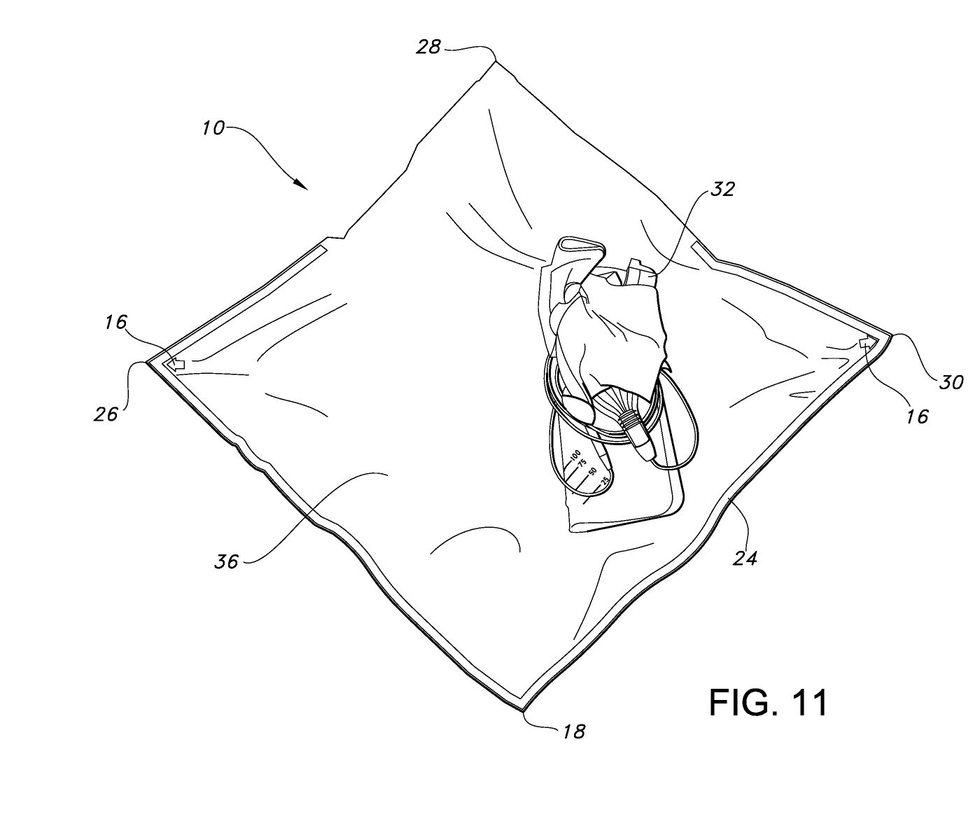

When it is desired to use the kit contents 32 held in the packaged kit the user can open the kit (FIG. 9) by grasping the exposed corners 26, 30 and pulling gently apart according to the instructional arrow in FIG. 10. This results in the complete unfurling of the packaged kit and the revealing of the kit contents 32 for the user. This method opens the package entirely, not partially and uniquely provides the user with a ready-to-use work sheet 36 to prepare the kit contents for usage as shown in FIG. 11. The work sheet 36 also provides liquid impervious protection for the area underlying the work sheet to avoid staining or wetting.

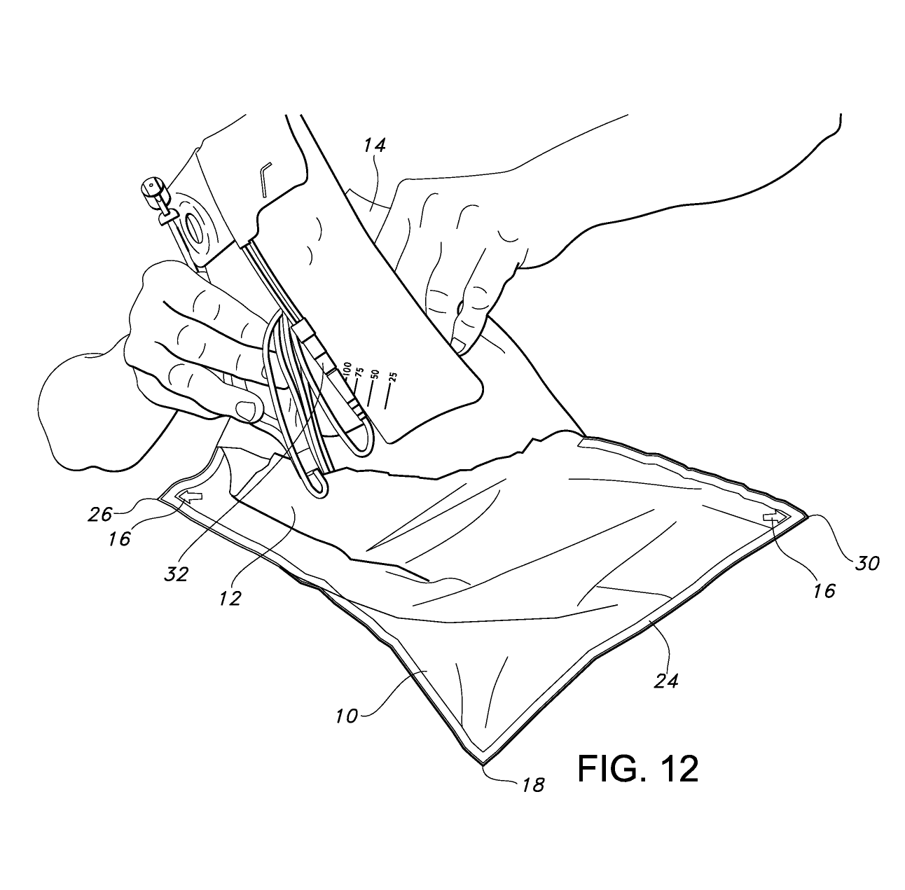

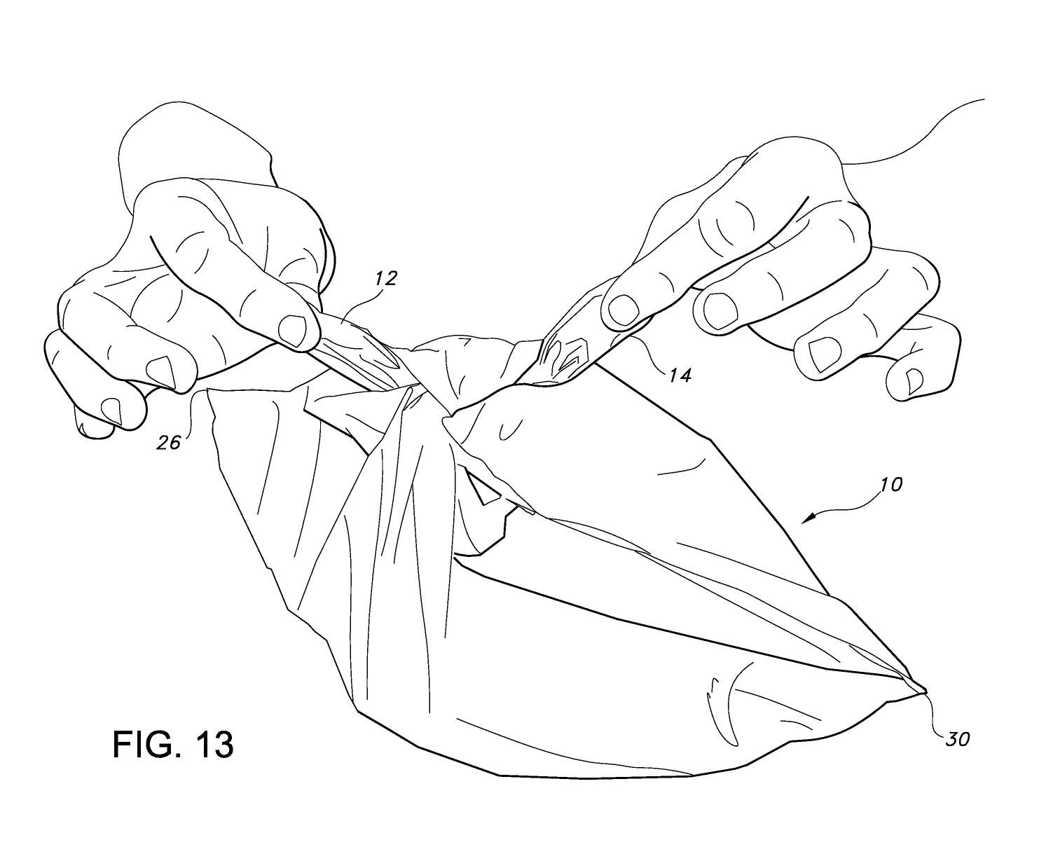

After draining the fluid from a pleural cavity and finishing the procedure, the user may dispose of kit contents and/or other items within the bag 10 as shown in FIG. 12. The sheets 12, 14 are separated at the open corner 28 and the used kit contents 32 inserted inside. The parts of the sheets 12, 14 at the open corner 28 may be tied together as shown in FIG. 13 and the bag 10 disposed of properly.

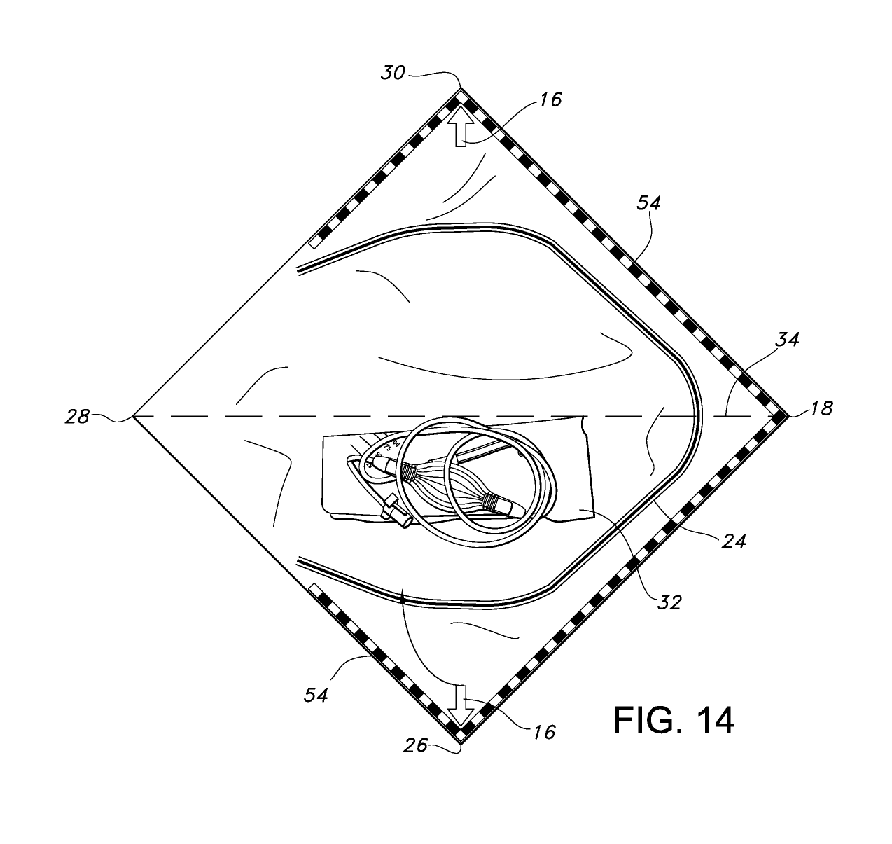

FIG. 14 shows an alternative embodiment in which the leak-proof or impervious seal 24 is not located at the perimeter but within the bag 10 between the superposed sheets 12, 14. The perimeter may be left unsealed or may be sealed with a pervious seal 54 or a secondary impervious seal if desired.

FIG. 15 shows another alternative embodiment in which the superposed sheets 12, 14 are made by folding over a single sheet, creating an edge between two corners 18, 26. The perimeter may be sealed with a leak-proof seal or a leak-proof seal may be included within the bag 10 as in FIG. 14.

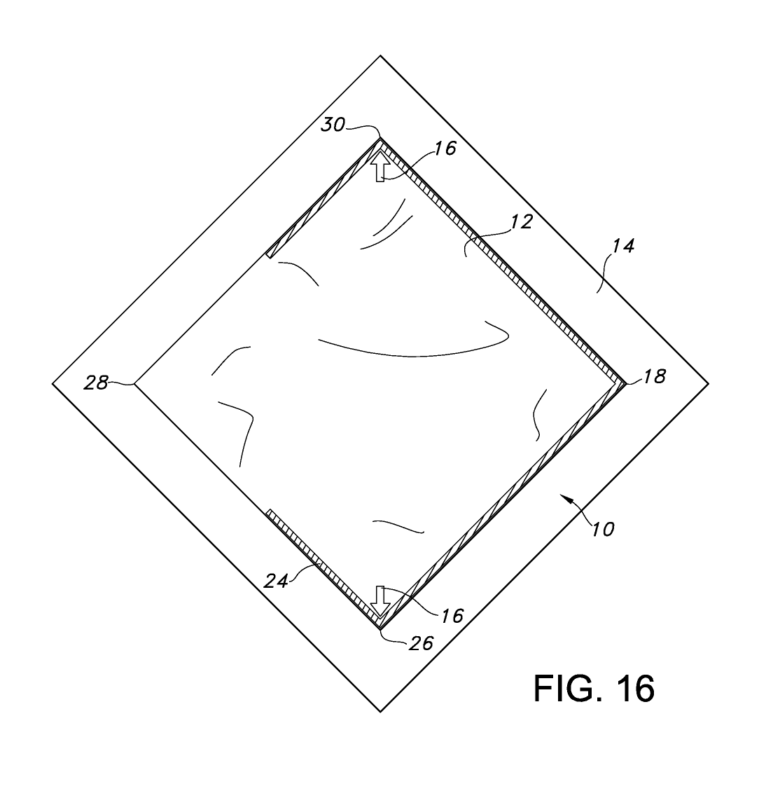

FIG. 16 shows yet another embodiment in which the superposed sheets are not the same size. In this embodiment the sheets are bonded around the perimeter of the smaller sheet 12 to create the bag 10. The larger sheet 14 provides for a larger work sheet and a larger underlying area that may be protected from liquid contact to avoid staining or wetting.

Either or both sheets 12, 14 of which the bag 10 is made may contain indicia that provide instructions to the user. These instructions may be symbolic, as in the form of an arrow 16 showing, for example, where the package should be grasped for opening (FIG. 10) or to indicate the location of the open corner. The instructions may be written in various languages and provide guidance on not only the disposal procedure but also the procedure for the use of the kit contents. Pictures of the use and disposal of the kit may be printed on the sheet(s) as well.

The two sheets 12, 14 may also be of differing colors, textures and/or may be pre-bonded with differing patterns. Such differences may be provided, for example, to improve the frictional characteristics of one of the sheets so that is does not slip on the underlying sheet on which it is disposed for use. Differences in coloration may also be used to indicate which side of the bag should be disposed downwardly or upwardly. Differing colors, textures, etc. may also be used simply to make the kit and/or bag more decorative and more appealing to the user.

As used herein and in the claims, the term “comprising” is inclusive or open-ended and does not exclude additional unrecited elements, compositional components, or method steps.

While various patents have been incorporated herein by reference, to the extent there is any inconsistency between incorporated material and that of the written specification, the written specification shall control. In addition, while the disclosure has been described in detail with respect to specific embodiments thereof, it will be apparent to those skilled in the art that various alterations, modifications and other changes may be made to the disclosure without departing from the spirit and scope of the present disclosure. It is therefore intended that the claims cover all such modifications, alterations and other changes encompassed by the appended claims.

What is claimed is:

1. A kit for drainage of a body cavity, the kit comprising;
instruments and supplies needed to drain the body cavity;
a disposal bag comprising two superposed, water impervious sheets having a perimeter and sealed about a substantial portion of the perimeter using a water impervious bond, the bag usable for disposal of the instruments and supplies after drainage of the body cavity.

2. The kit of claim 1 wherein one of said superposed sheets forms a work surface to prepare and use said instruments and supplies.

3. The kit of claim 1 wherein said instruments and supplies comprise gloves and a drainage bag.

4. The kit of claim 1 wherein said perimeter is bonded together for a length between 50 and 90 percent of said perimeter.

5. The kit of claim 4 wherein said perimeter is bonded together for a length between 70 and 80 percent of said perimeter.

6. The kit of claim 1 wherein said sheets are bonded together within the bag between the superposed sheets.

7. The kit of claim 1 wherein said sheets comprise nonwoven fabric.

8. The kit of claim 7 wherein said sheets further comprise a film layer.

9. The kit of claim 1 wherein one of said sheets is larger than the other.

10. The kit of claim 1 wherein at least one of said sheets has instructions for use of said drainage kit.

11. The kit of claim 1 wherein said sheets are different in color from each other.

12. The kit of claim 1 wherein said sheets are different in texture from each other.

13. A method of forming a drainage kit comprising the steps of;
superposing two sheets to form a bag that has a flat work sheet and upper, lower, left and right corners,
placing kit contents off center on said work sheet,
folding the lower corner of the bag up over a portion of the kit,
folding back the tip of the lower corner over a portion of said corner,
folding the upper corner over the lower corner,
folding the left corner towards the right corner,
folding the right corner towards the left corner,
folding the upper corner up to cover the tips of the left and right corners.
